(19) United States
(12) Patent Application Publication
(10) Pub. No.: US 2014/0247604 A1
(43) Pub. Date: Sep. 4, 2014

(54) THIN LED LENS

(71) Applicants: LEDLINK OPTICS, INC., New Taipei City (TW); LEDLINK OPTICS (DONG GUAN) CO., LTD., Guangdong (CN); YANG ZHOU LEDLINK OPTICS CO., LTD., Jiangsu Province (CN)

(72) Inventors: TE-LUNG TANG, NEW TAIPEI CITY (TW); CHIH-MING WEI, NEW TAIPEI CITY (TW)

(73) Assignees: LEDLINK OPTICS, INC., NEW TAIPEI CITY (TW); YANG ZHOU LEDLINK OPTICS CO., LTD., JIANGSU PROVINCE (CN); LEDLINK OPTICS (DONG GUAN) CO., LTD., GUANGDONG (CN)

(21) Appl. No.: 13/783,949

(22) Filed: Mar. 4, 2013

(51) Int. Cl. F21V 5/04

(52) U.S. Cl. CPC F21V 5/046
USPC 362/311.02

(57) ABSTRACT

Disclosed is a thin LED lens including a lens body being an inverted frusto-conical shaped structure, a light exit surface formed on a non-frustum end of the lens body, and an accommodating chamber formed at a frustum end of the lens body, characterized in that the accommodating chamber has a primary accommodating chamber and at least one secondary accommodating chamber disposed around the primary accommodating chamber, such that the primary accommodating chamber and the secondary accommodating chamber are arranged in a concentric and radial shape, and the secondary accommodating chamber is in form of a circular groove. The thin LED lens can be made thinner to achieve the effects of facilitating the manufacture, reducing the material, and providing a better light distribution.

### BACKGROUND OF THE INVENTION

1. Field of the Invention

The present invention relates to a thin light emitting diode (LED) lens, and more particularly to the thin LED lens with a small thickness to facilitate the manufacture and provides better light distribution.

2. Description of the Related Art

Most conventional lens structures are used in light emitting modules. As science and technology advance, the light emitting modules are developed with a thinner, lighter and smaller design while maintaining a good light distribution effect of a light emitting source. In general, the thickness of the LED optical lens or the diameter width of the light exit surface is adjusted to meet the actual requirements of an illumination range and a uniform luminous intensity.

With reference to FIGS. 1 to 3 for a ray tracing diagram, a light distribution curve and an irradiance diagram of an embodiment of a conventional LED lens respectively, a conventional lens body 900 is combined with an LED emission light source, and the maximum luminous intensity at the center of the emission light source) (ω=0°) is approximately equal to 2000 cd, and the maximum luminance at the center position on the X-Z plane is approximately equal to 2000 lux. However, the conventional lens has a greater thickness, so that when the lens is applied in a light emitting module, the total thickness is also increased. As a result, the dimensions of the light emitting module are further limited.

With reference to FIGS. 4 to 6 for a ray tracing diagram, a light distribution curve and an irradiance diagram of another embodiment of a conventional LED lens respectively, FIG. 1 and FIG. 4 are compared, and the comparison result shows that the lens body 800 of this preferred embodiment is thinner than the previous lens body 900.

In other words, the previous lens body 900 can be cut thinner to obtain the lens body 800 of this preferred embodiment.

In FIGS. 4 to 6, although the thickness, weight and volume of the lens body 800 are reduced, the maximum luminous intensity at the center of the emission light source) (ω=0°) is approximately equal to 1300 cd, and the maximum luminance at the center position on the X-Z plane is approximately equal to 1400 lux. In other words, if the conventional lens is cut thinner, the thickness, weight and volume of the lens can be reduced, yet the level of difficulty of the design is higher, and thus the required range and effect of the illumination can not be achieved.

As to the requirements, the design of a thin LED lens uses less material and has a smaller weight and a smaller volume, and meanwhile the thin LED lens combined with LED to emit a better light distribution than the regular lens has become a major subject that demands immediate attention in the market.

### SUMMARY OF THE INVENTION

In view of the aforementioned problems of the prior art, it is a primary objective of the present invention to overcome the problems by providing a thin LED lens that uses less material to manufacture the lens while providing a better light distribution.

To achieve the aforementioned objective, the present invention provides a thin LED lens comprising a lens body which is an inverted frusto-conical shaped structure, a light exit surface formed on a non-frustum end of the lens body, and an accommodating chamber formed at a frustum end of the lens body, characterized in that the accommodating chamber has a primary accommodating chamber and at least one secondary accommodating chamber disposed around the primary accommodating chamber, so that the primary accommodating chamber and the secondary accommodating chamber are arranged in a concentric and radial shape, and the secondary accommodating chamber is in form of a circular groove.

In a preferred embodiment, the primary accommodating chamber is formed by a sidewall surface connecting around a bottom surface, and the bottom surface is in a planar shape, a convex arc shape or a concave arc shape with respect to the lens body. The thin LED lens further comprises a diffusion portion coupled to the lens body and disposed around the light exit surface, and the diffusion portion has a plurality of ribs formed on a surface of the diffusion portion. The light exit surface has a plurality of bumps distributed in form of a dot pattern.

In another preferred embodiment, there are two secondary accommodating chambers, and a hollow hole is concavely formed in a central area of the light exit surface and facing towards the lens body. Wherein, the light exit surface at the position of the hollow hole is in a convex arc shape with respect to the lens body and has a plurality of bumps distributed in form of a dot pattern.

To achieve the aforementioned objective, the present invention further uses a preferred embodiment for the illustration, wherein there are two secondary accommodating chambers in this preferred embodiment and the light exit surface is concaved towards the lens body and has a plurality of bumps formed at a central area of the light exit surface and distributed in form of a dot pattern.

### BRIEF DESCRIPTION OF THE DRAWINGS

FIG. 1 is a ray tracing diagram of an embodiment of a conventional LED lens;

FIG. 2 is a light distribution curve of an embodiment of a conventional LED lens;

FIG. 3 is an irradiance diagram of an embodiment of a conventional LED lens;

FIG. 4 is a ray tracing diagram of another embodiment of a conventional LED lens;

FIG. 5 is a light distribution curve of another embodiment of a conventional LED lens;

FIG. 6 is an irradiance diagram of another embodiment of a conventional LED lens;

FIG. 7 is a cross-sectional view of a thin LED lens of a first preferred embodiment of the present invention;

FIG. 8 is a ray tracing diagram of a thin LED lens of the first preferred embodiment of the present invention;

FIG. 9 is a light distribution curve of a thin LED lens of the first preferred embodiment of the present invention;

FIG. 10 is an irradiance diagram of a thin LED lens of the first preferred embodiment of the present invention;

FIG. 11 is a perspective view of a thin LED lens of a second preferred embodiment of the present invention;

FIG. 12 is a cross-sectional view of a thin LED lens of the second preferred embodiment of the present invention;

FIG. 13 is a ray tracing diagram of a thin LED lens of the second preferred embodiment of the present invention;

FIG. 14 is a light distribution curve of a thin LED lens of the second preferred embodiment of the present invention;

FIG. 15 is an irradiance diagram of a thin LED lens of the second preferred embodiment of the present invention;

FIG. 16 is a perspective view of a thin LED lens of a third preferred embodiment of the present invention;

FIG. 17 is a cross-sectional view of a thin LED lens of the third preferred embodiment of the present invention;

FIG. 18 is a ray tracing diagram of a thin LED lens of the third preferred embodiment of the present invention;

FIG. 19 is a light distribution curve of a thin LED lens of the third preferred embodiment of the present invention;

FIG. 20 is an irradiance diagram of a thin LED lens of the third preferred embodiment of the present invention;

FIG. 21 is a perspective view of a thin LED lens of a fourth preferred embodiment of the present invention; and

FIG. 22 is a cross-sectional view of a thin LED lens of the fourth preferred embodiment of the present invention.

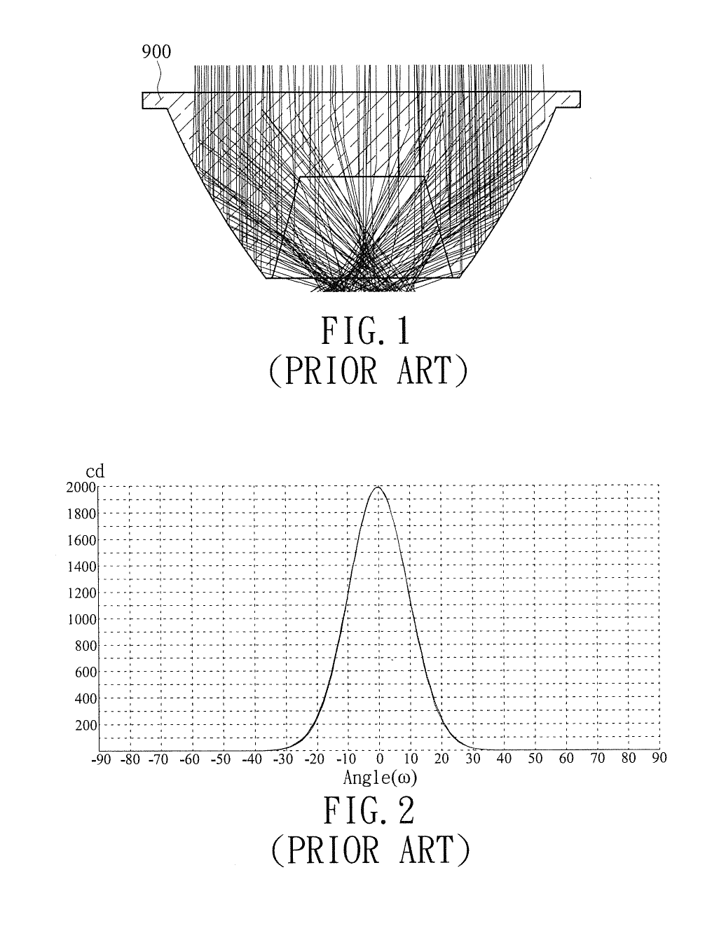

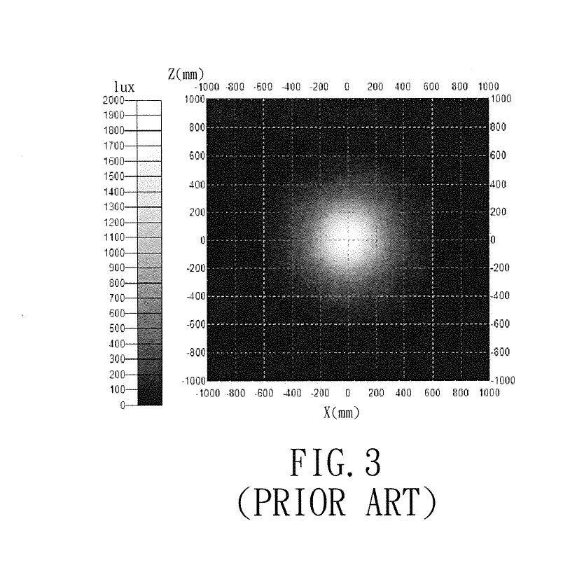

### DETAILED DESCRIPTION OF THE PREFERRED EMBODIMENTS

The technical content of the present invention will become apparent with the detailed description of preferred embodiments and the illustration of related drawings as follows. It is noteworthy that same numerals are used for representing same respective elements in the drawings.

The thin LED lens of the present invention can be combined with an LED for guiding lights of the LED to produce a better light pattern.

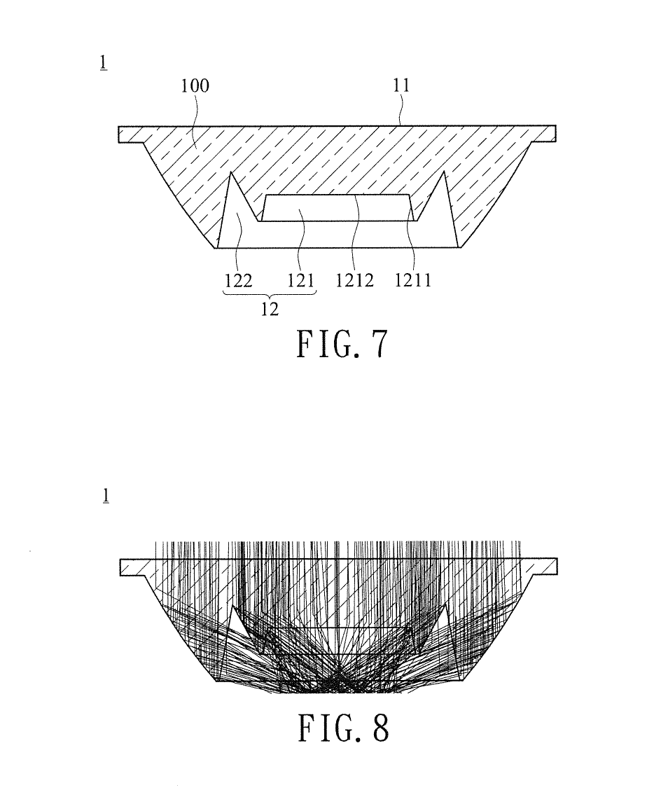

With reference to FIGS. 7 to 10 for a cross-sectional view, a ray tracing diagram, a light distribution curve and an irradiance diagram of a thin LED lens 1 of the first preferred embodiment of the present invention respectively, the thin LED lens 1 as shown in FIG. 7 comprises a lens body 100 which is an inverted frusto-conical shaped structure, a light exit surface 11 formed at a non-frustum end of the lens body 100, and an accommodating chamber 12 formed at a frustum end of the lens body 100.

The accommodating chamber 12 has a primary accommodating chamber 121 and a secondary accommodating chamber 122 disposed around the primary accommodating chamber 121, so that the primary accommodating chamber 121 and the secondary accommodating chamber 122 are arranged in a concentric and radial shape, and the secondary accommodating chamber 122 is disposed around the primary accommodating chamber 121 to form a circular groove, and the bottom of the groove is in a sharp shape. Wherein, the primary accommodating chamber 121 is formed by a sidewall surface 1211 connecting around a bottom surface 1212, and the bottom surface 1212 is in a planar shape with respect to the lens body 100.

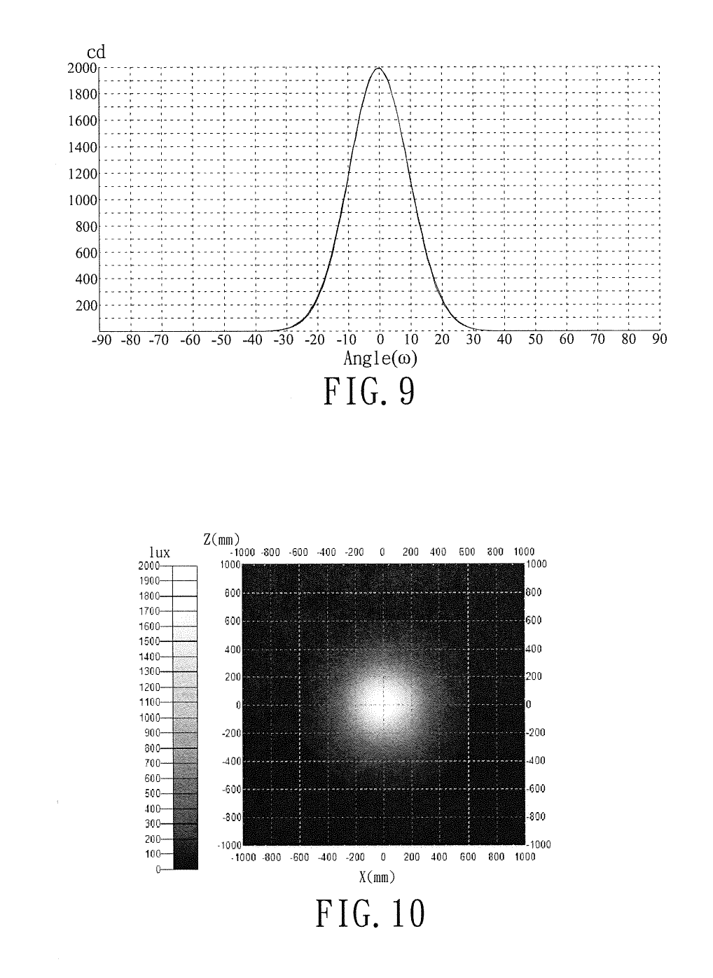

When an LED is installed in the accommodating chamber 12 as shown in FIGS. 8 and 9, the light emitted by the LED can be passed through the lens body and refracted or reflected, so that the light path can be shifted to produce a better illumination effect. The maximum luminous intensity at the center of the emission light source) (ω=0°) is approximately equal to 2000 cd, and the luminous intensity is greater and has a full angle approximately equal to 40°. In FIG. 10, the maximum luminance at the central position on the X-Z plane is preferably equal to 2000 lux.

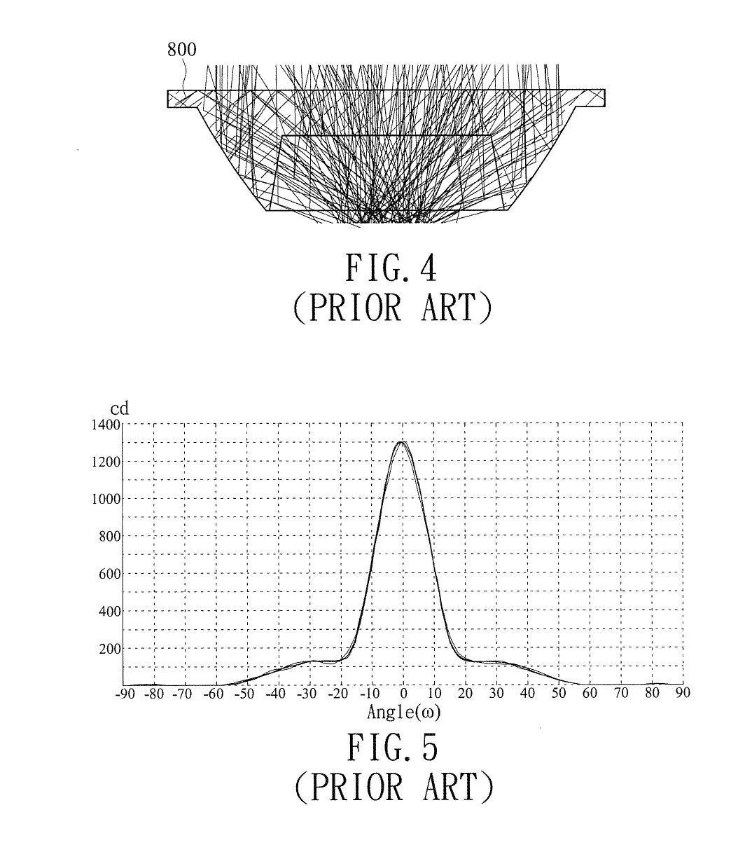

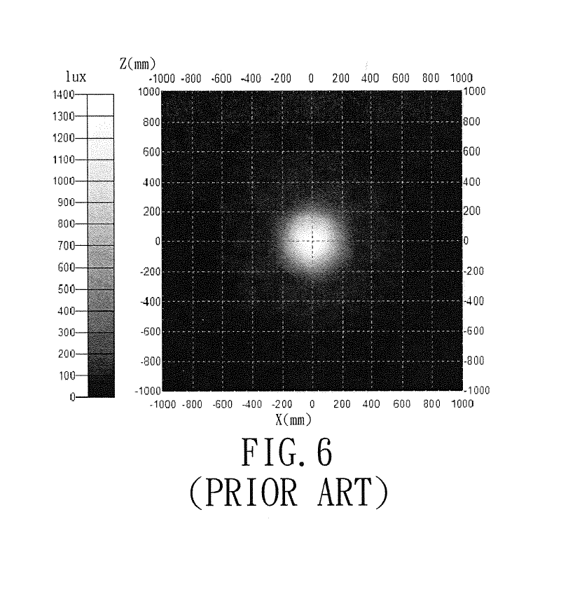

Compared with the conventional lenses 800, 900 as shown in FIGS. 1 and 4, the thin LED lens 1 of the present invention reduces the use of material of the lens while maintaining the same luminous intensity and luminance. In other words, the thin LED lens 1 of the present invention can reduce the volume of the conventional lens body and fit in the application for any compact or thin lamps to avoid occupying too much space.

Based on the first preferred embodiment, the present invention further provides a second preferred embodiment and a third preferred embodiment as examples for the illustration the present invention.

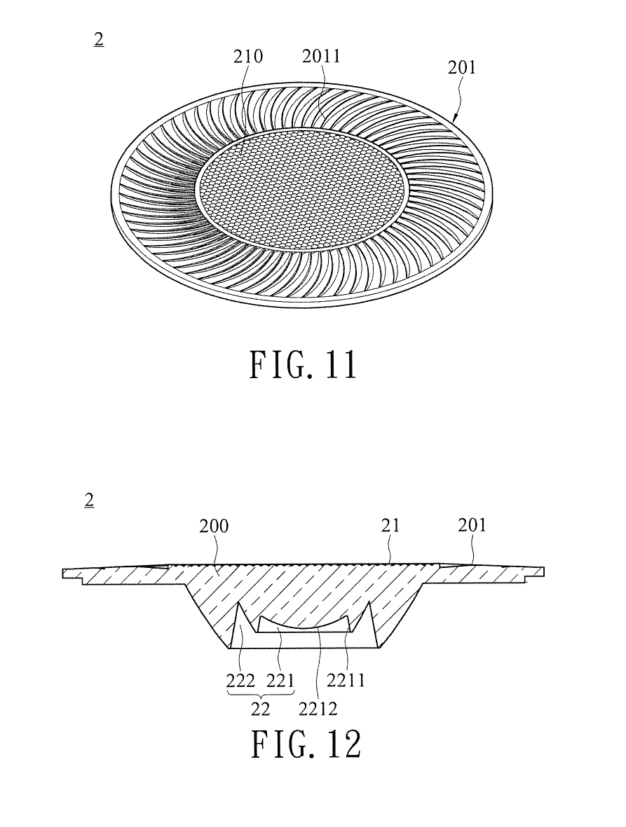

With reference to FIGS. 11 to 15 for a perspective view, a cross-sectional view, a ray tracing diagram, a light distribution curve and an irradiance diagram of a thin LED lens 2 in accordance with the second preferred embodiment of the present invention respectively, the difference between the thin LED lens 2 of this preferred embodiment as shown in FIGS. 11 and 12 and the first preferred embodiment resides on that the light exit surface 21 has a plurality of bumps 210 distributed in a dot pattern. The bumps 210 are provided for guiding the light of the LED to diverge a light path and enhance the light uniformity. The primary accommodating chamber 221 is formed by a sidewall surface 2211 connecting around a bottom surface 2212, and the bottom surface 2212 is in a convex arc shape with respect to the lens body 200. The thin LED lens 2 further comprises a diffusion portion 201 coupled to the lens body 200 and disposed around the light exit surface 21, wherein the diffusion portion 201 has a plurality of ribs 2011 disposed on a surface of the diffusion portion 201 and arranged in a whirlpool shape.

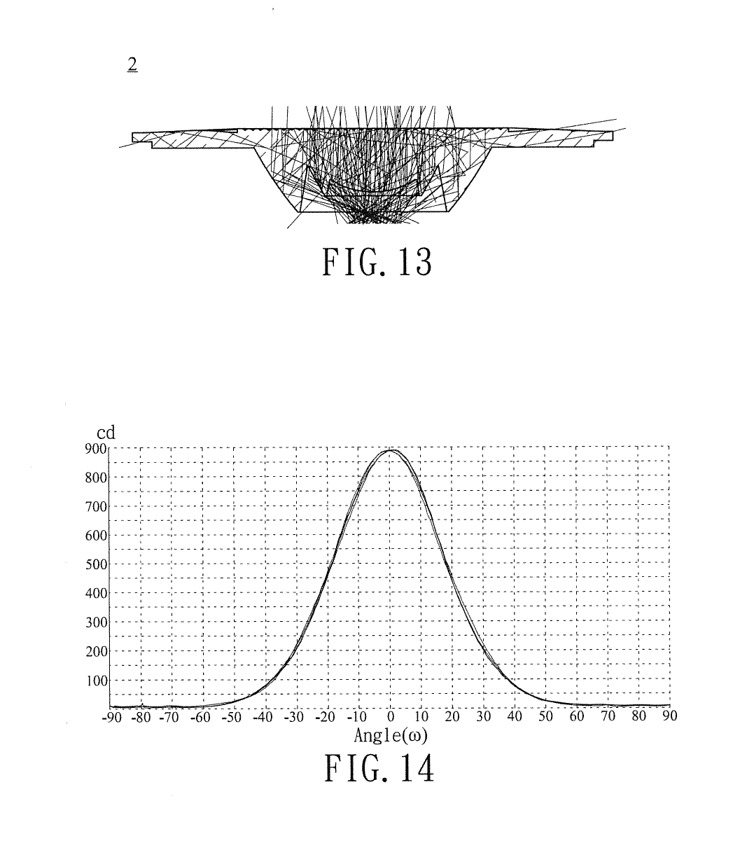

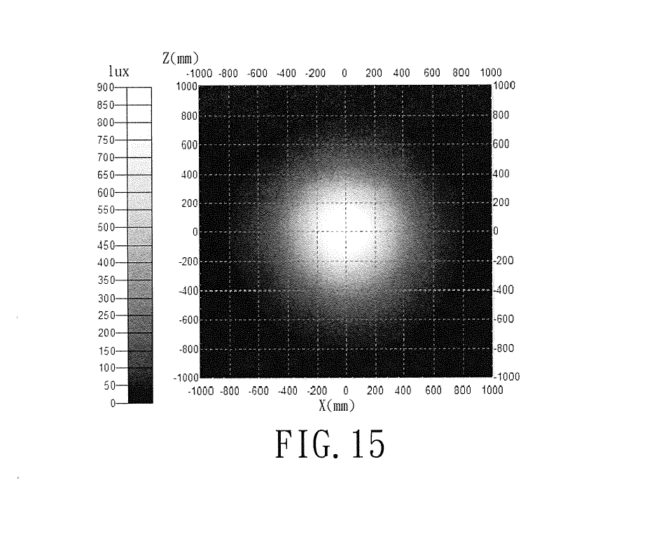

In FIGS. 13 and 14, the maximum luminous intensity at the center of the emission light source) (ω=0°) is approximately equal to 900 cd, and the luminous intensity is greater and has a full angle approximately equal to 80° as shown in FIG. 15, and the maximum luminance at the central position on the X-Z plane is preferably equal to 900 lux.

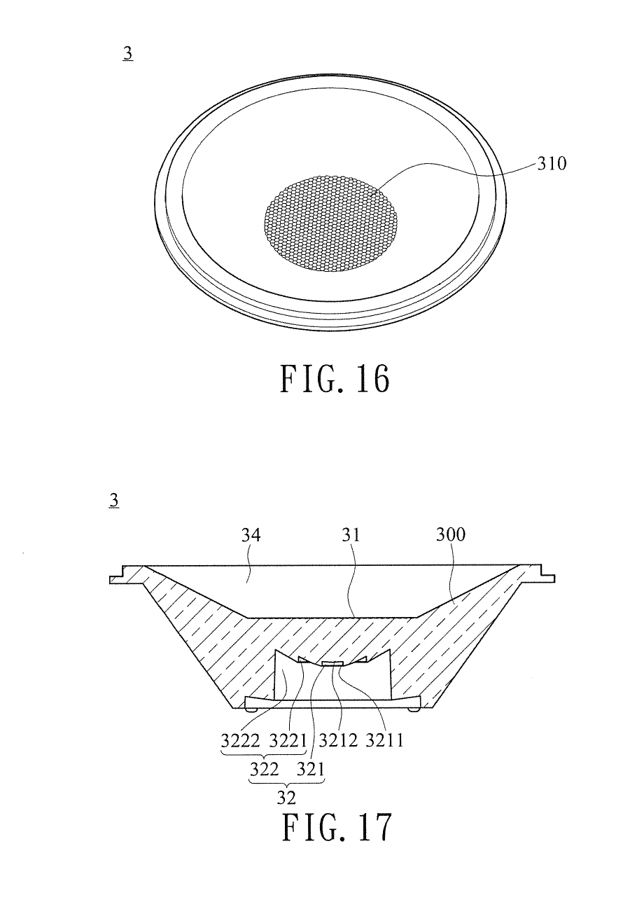

With reference to FIGS. 16 to 20 for a perspective view, a cross-sectional view, a ray tracing diagram, a light distribution curve and an irradiance diagram of a thin LED lens 3 in accordance with the third preferred embodiment of the present invention respectively, the difference between the thin LED lens 3 of this preferred embodiment as shown in FIGS. 16 and 17 and the first preferred embodiment resides on that the light exit surface 31 is concaved towards the lens body 300, and the light exit surface 31 has a plurality of bumps 310 formed in the central area of the light exit surface 31 and distributed in a dot pattern.

In addition, the accommodating chamber 32 has a primary accommodating chamber 321 and a plurality of secondary accommodating chambers 322. Each secondary accommodating chambers 322 includes a first secondary accommodating chamber 3221 and a second secondary accommodating chamber 3222, and the second secondary accommodating chamber 3222 is disposed around the external periphery of the first secondary accommodating chamber 3221, and the first secondary accommodating chamber 3221 is disposed around the edge of the primary accommodating chamber 321, so that the primary accommodating chamber 321 and the plurality of secondary accommodating chambers 322 are arranged concentrically and adjacent to each other.

It is noteworthy that the cup-shaped surface of the lens body 300 can be designed with a mesh form, a cellular honeycomb structure or a frosted glass treatment to diverge the light path of the LED, so as to enhance the light uniformity.

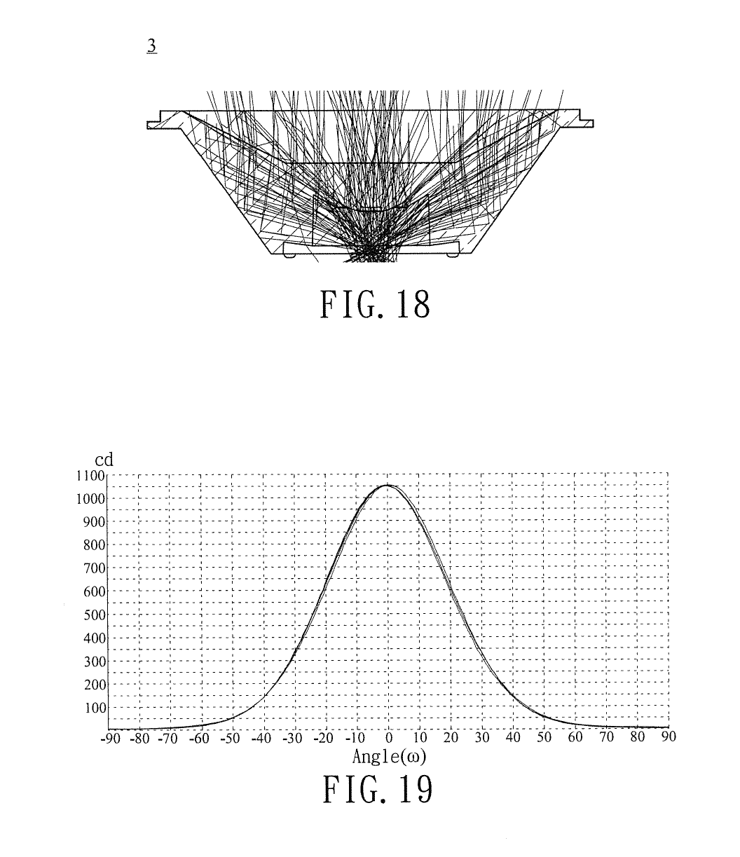

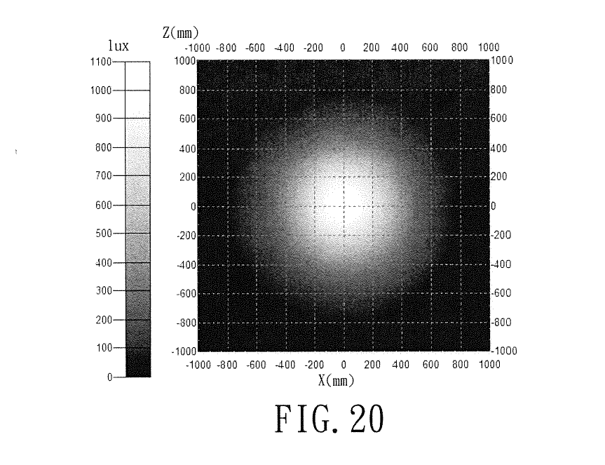

In FIGS. 18 and 19, the maximum luminous intensity at the center of the emission light source) (ω=0°) is approximately equal to 1050 cd and the luminous intensity is greater and has a full angle approximately equal to 88° as shown in FIG. 20, and the maximum luminance at the center position on the X-Z plane is preferably equal to 1100 lux.

Based on the first to the third preferred embodiments, the present invention further uses a fourth preferred embodiment as an example for illustrating the present invention.

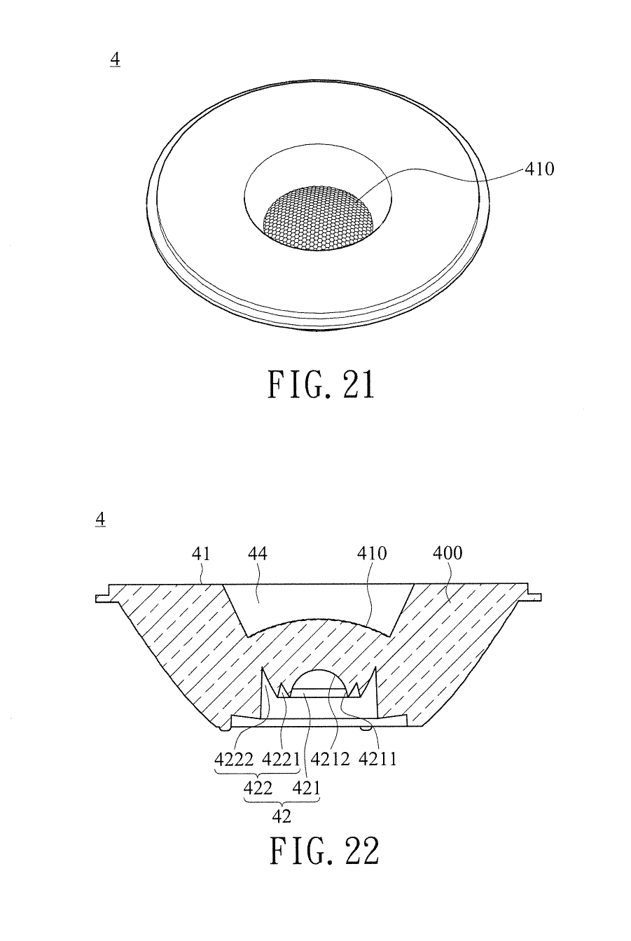

With reference to FIGS. 21 and 22 for a perspective view and a cross-sectional view of thin LED lens in accordance with a fourth preferred embodiment of the present invention respectively, the thin LED lens 4 of the present invention has a lens body 400 which is substantially an inverted frusto-conical shaped structure, and a light exit surface 41 is formed at a non-frustum end of the lens body 400, and the central area of the light exit surface 41 is concaved towards the lens body 400 to from a hollow hole 44, and the light exit surface 41 at the position of the hollow hole 44 is in a convex arc shape with respect to the lens body 400. When a light exits, the light is received by the surface of the light exit surface 41 and a plurality of bumps 410 is provided and distributed in a dot pattern.

The frustum end is concavely sunken towards the lens body 400 to form an accommodating chamber 42 including a primary accommodating chamber 421 and a plurality of secondary accommodating chambers 422 disposed around the primary accommodating chamber 421. Each secondary accommodating chamber 422 includes a first secondary accommodating chamber 4221 and a second secondary accommodating chamber 4222, and the second secondary accommodating chamber 4222 is disposed around the external periphery of the first secondary accommodating chamber 4221, and the first secondary accommodating chamber 4221 is disposed around the edge of the primary accommodating chamber 421, so that the primary accommodating chamber 421 and the secondary accommodating chambers 422 are arranged in a concentric and radial shape. The quantity of the secondary accommodating chambers 422 are two and the secondary accommodating chambers are disposed adjacent to each other and arranged in form of a circular groove.

The primary accommodating chamber 421 is formed by a sidewall surface 4211 connecting around a bottom surface 4212, and the bottom surface 4212 is in a concave arc shape with respect to the lens body 400 and capable of guiding and diverging the light of the LED.

In addition, the cup-shaped surface of the lens body 400 is designed with a mesh form, a cellular honeycomb structure, or a frosted glass treatment to diverge the light path of the LED, so as to enhance the light uniformity.

What is claimed is:

1. A thin LED lens, comprising a lens body being an inverted frusto-conical shaped structure, a light exit surface formed on a non-frustum end of the lens body, and an accommodating chamber formed at a frustum end of the lens body, characterized in that the accommodating chamber has a primary accommodating chamber and at least one secondary accommodating chamber disposed around the primary accommodating chamber, such that the primary accommodating chamber and the secondary accommodating chamber are arranged in a concentric and radial shape, and the secondary accommodating chamber is in form of a circular groove.

2. The thin LED lens of claim 1, wherein the primary accommodating chamber is formed by a sidewall surface connecting around a bottom surface, and the bottom surface is in a planar shape, a convex arc shape or a concave arc shape with respect to the lens body.

3. The thin LED lens of claim 2, further comprising: a diffusion portion coupled to the lens body and around the light exit surface, and the diffusion portion has a plurality of ribs formed on a surface of the diffusion portion.

4. The thin LED lens of claim 3, wherein the light exit surface has a plurality of bumps distributed in form of a dot pattern.

5. The thin LED lens of claim 2, wherein the secondary accommodating chamber comes with a quantity of two, and a central area of the light exit surface concavely form a hollow hole towards the lens body.

6. The thin LED lens of claim 5, wherein the light exit surface at the position of the hollow hole is in a convex arc shape with respect to the lens body and has a plurality of bumps distributed in form of a dot pattern.

7. The thin LED lens of claim 1, wherein the secondary accommodating chamber comes with a quantity of two, the light exit surface concaves towards the lens body and a plurality of bumps distributed in form of a dot pattern in a central area of the light exit surface.
